(19) United States
(12) Patent Application Publication
(10) Pub. No.: US 2012/0013187 A1
(43) Pub. Date: Jan. 19, 2012

(54) METHOD AND CIRCUIT FOR CURRENT BALANCE

(76) Inventor: Junming Zhang, Hangzhou (CN)

(21) Appl. No.: 13/181,861

(22) Filed: Jul. 13, 2011

(30) Foreign Application Priority Data
Jul. 14, 2010 (CN) 201010229852.X

(51) Int. Cl. H02M 7/06

(52) U.S. Cl. 307/31; 363/126

(57) ABSTRACT

This disclosure presents method and circuit for current balance. An AC signal or a DC signal is applied to a circuit to source current to loads. A capacitor is configured to balance the current in loads. By matching the charging time and the discharging time of the balance capacitor in every cycle, the current balance of the loads is achieved.

### CROSS-REFERENCE TO RELATED APPLICATION(S)

This application claims priority to and the benefit of Chinese Patent Application No. 201010229852.X, filed Jul. 14, 2010, which is incorporated herein by reference in its entirety.

### TECHNICAL FIELD

The present disclosure relates generally to isolated power supply, and more specifically to a circuit and related method for current balance.

### BACKGROUND

LEDs have become increasingly popular as a lighting choice and, for many applications, LEDs have begun to replace conventional filament light bulbs. For example, LEDs are now widely used in traffic signal lights and for the back lighting of liquid crystal display (LCD) panels.

LEDs are often arranged in parallel “strings” driven by a shared voltage source, and each LED string has a plurality of LEDs connected in series. Parallel LED strings driven by a shared voltage source often have current unbalance problems due to the considerable variation in the static forward-voltage drops of individual LEDs of the LED strings resulting from process variations in the fabrication and manufacturing of the LEDs. Dynamic variations due to changes in temperature when the LEDs are enabled and disabled also may contribute to the variation in static forward-voltage drops of individual LEDs.

To provide consistent light output between the LED strings, several current balance techniques have been presented.

FIG. 1 schematically shows a prior art LED driver with linear current source control. In FIG. 1, a voltage V_{cc} is supplied to every LED string, and each LED string is series-coupled to a respective current source. Each current source comprises: an amplifier U₀, a switch M₁ and a resister R connected as shown. The switch M₁ is controlled by the output of the amplifier U₀. The switch M₁ may comprise a MOSFET. The voltage across the resistor R is clamped to a reference voltage V_{REF} by the amplifier U₀, so the current flowing through the resistor R is fixed to V_{REF}/R. In this example, the current flowing through the resistor R is also the current flowing in each LED string. So current balance in different LED strings could be achieved by adopting a same reference voltage V_{REF} in different current sources. But when there is deviation in the driving voltages of LED strings, an excessively high driving voltage is needed, in which case, the power dissipated by the current source may be large.

FIG. 2 schematically shows a prior art LED driver with switching power supply control. In FIG. 2, every LED string is controlled by a DC/DC converter. Each LED string is configured as a load of each DC/DC converter. Compared to the example in FIG. 1, the efficiency of the example in FIG. 2 is improved. But each LED string requires a dedicated DC/DC converter, which makes the system complicated and increases the cost.

The present disclosure provides a method and circuit for current balance. It achieves current balance among the loads efficiently with simple structure and low cost.

### SUMMARY

It is an object of the present disclosure to provide a circuit and related method which achieves the current balance with simple structure and low cost.

In accomplishing the above and other objects, there has been provided, in accordance with an embodiment of the present disclosure, a circuit, comprising: a transformer comprising a primary winding and a secondary winding, wherein the primary winding is coupled to an AC signal, and the secondary winding has a first terminal and a second terminal; a balance capacitor having a first terminal and a second terminal, wherein the first terminal of the balance capacitor is coupled to the first terminal of the secondary winding of the transformer; and a secondary converter having a first input terminal, a second input terminal, a first output terminal, and a second output terminal, wherein the first input terminal is coupled to the second terminal of the balance capacitor, the second input terminal is coupled to the second terminal of the secondary winding of the transformer, and either the first or second output terminal provides a drive signal to a load.

In addition, there has been provided, in accordance with an embodiment of the present invention, a circuit comprising: a transformer set comprising N transformers, wherein N is a natural number, and each transformer respectively comprises a primary winding and a secondary winding, wherein all the primary windings are serially coupled to an AC signal, and each secondary winding has a first terminal and a second terminal; a balance capacitor set comprising N balance capacitors, wherein N is a natural number, and wherein each balance capacitor has a first terminal and a second terminal, wherein the first terminal of each balance capacitor is respectively coupled to the first terminal of each secondary winding of the transformer group; and a secondary converter set comprising N secondary converters, wherein N is a natural number, and wherein each secondary converter has a first input terminal, a second input terminal, a first output terminal, and a second output terminals, wherein the first input terminal of each secondary converter is respectively coupled to the second terminal of each balance capacitor, the second input terminal of each secondary converter is respectively coupled to the second terminal of each secondary winding of the transformer set, and each output terminal of the secondary converter set provides a drive signal to a respective load.

In addition, there has been provided, in accordance with an embodiment of the present disclosure, a method of current balance, comprising: receiving an AC signal; transferring the AC signal from a primary winding to a secondary side of a transformer to source current to a plurality of loads; balancing the current flowing through each of the respective loads by a balance capacitor.

### BRIEF DESCRIPTION OF THE DRAWINGS

FIG. 1 schematically shows a prior art LED driver with linear current source control.

FIG. 2 schematically shows a prior art LED driver with switching power supply control.

FIG. 3 schematically shows a circuit 100 in accordance with an embodiment of the present disclosure.

FIG. 4 shows the waveforms of signals in the circuit 100 in FIG. 3.

FIG. 5 schematically shows a circuit 200 in accordance with an embodiment of the present disclosure.

FIG. 6 schematically shows a circuit 300 in accordance with an embodiment of the present disclosure.

FIG. 7 schematically shows a circuit 400 in accordance with an embodiment of the present disclosure.

FIG. 8 schematically shows a circuit 500 in accordance with an embodiment of the present disclosure.

FIG. 9 schematically shows a circuit 600 in accordance with an embodiment of the present disclosure

FIG. 10 shows a schematic flowchart 700 of a method of current balance in accordance with an embodiment of the present disclosure.

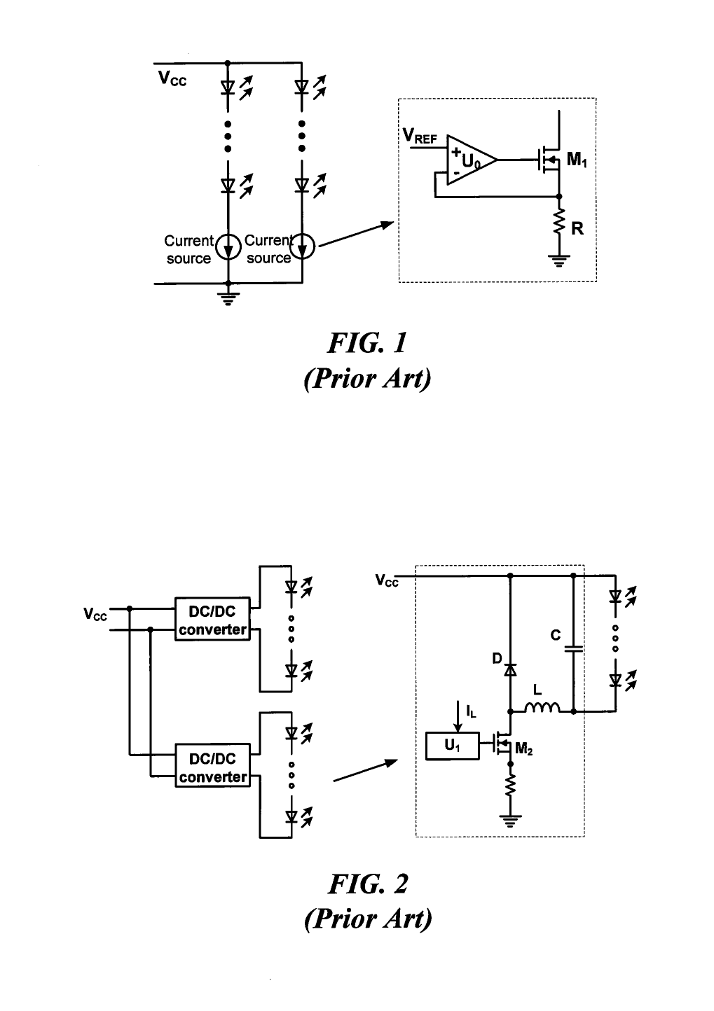

The use of the same reference label in different drawings indicates the same or similar components.

### DETAILED DESCRIPTION

In the present disclosure, numerous specific details are provided, such as examples of circuits, components, and methods, to provide a thorough understanding of embodiments of the disclosure. Persons of ordinary skill in the art will recognize, however, that the disclosure can be practiced without one or more of the specific details. In other instances, well-known details are not shown or described to avoid obscuring aspects of the disclosure.

The present disclosure takes paralleled coupled LED strings as loads, but persons of ordinary skill in the art should realize that the LED strings could be replaced by other loads.

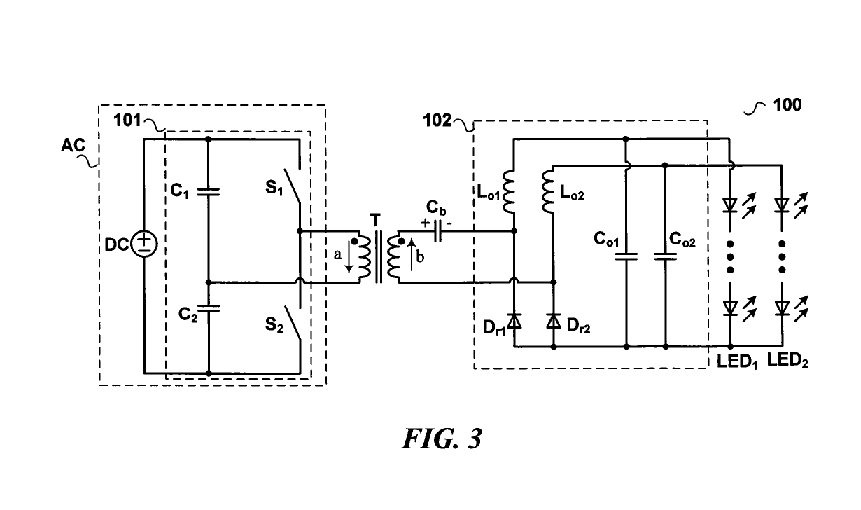

FIG. 3 schematically shows a circuit 100 in accordance with an embodiment of the present disclosure. In FIG. 3, the circuit 100 comprises: a primary converter 101 configured to receive a DC signal, and to provide an AC signal based thereupon; a transformer T comprising a primary winding and a secondary winding, wherein the primary winding is coupled to the AC signal, and the secondary winding has a first terminal and a second terminal; a balance capacitor C_{b}, having a first terminal and a second terminal, wherein the first terminal of the balance capacitor C_{b} is coupled to the first terminal of the secondary winding of the transformer T; and a secondary converter 102 having a first input terminal, a second input terminal, a first output terminal, and a second output terminal, wherein the first input terminal is coupled to the second terminal of the balance capacitor C_{b}, the second input terminal is coupled to the second terminal of the secondary winding of the transformer T; either the first or second output terminal provides a drive signal to a load.

In the example of FIG. 3, the primary converter 101 comprises a half-bridge converter comprised by a first switch S₁ and a second switch S₂. Persons of ordinary skill in the art should know that the primary converter may comprise other topologies, for example, full-bridge, push-pull, and some active clamp topologies. Different primary converters result in different AC signals, for example, rectangular waves, triangular waves and semi-round waves, and so on.

In the example of FIG. 3, the secondary converter 102 comprises: a first diode Dᵣ₁ having a cathode and an anode, wherein the cathode is coupled to the first input terminal of the secondary converter 102, and the anode is coupled to a ground node; a second diode Dᵣ₂ having a cathode and an anode, wherein the cathode is coupled to the second input terminal of the secondary converter 102, and the anode is coupled to the ground node; a first inductor Lₒ₁ coupled between the first input terminal of the secondary converter 102 and the first output terminal of the secondary converter 102; and a second inductor Lₒ₂ coupled between the second input terminal of the secondary converter 102 and the second output terminal of the secondary converter 102.

The secondary converter 102 in the example of FIG. 3 further comprises: a first output capacitor Cₒ₁ coupled between the first output terminal of the secondary converter 102 and the ground node; a second output capacitor Cₒ₂ coupled between the second output terminal of the secondary converter 102 and the ground node.

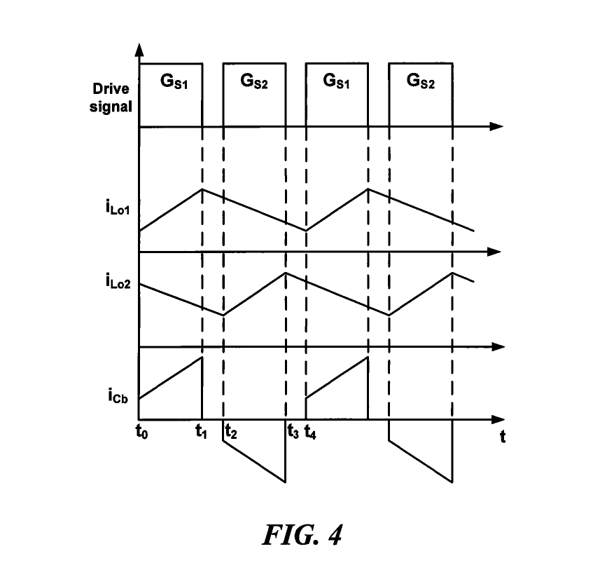

FIG. 4 shows the waveforms of signals in the circuit 100 of FIG. 3, the function of the balance capacitor C_{b} is described with referring to FIGS. 3 and 4.

In FIG. 4, the horizontal axis represents time; G_{S1} and G_{S2} represent the drive signals of the first switch S₁ and the second switch S₂; Subinterval t₀-t₄ represents an operation cycle of the circuit 100; Subinterval t₁-t₂ and subinterval t₃-t₄ represent dead times needed for preventing large current from source to ground. During subinterval t₀-t₁, the first switch S₁ is turned on, and the second switch S₂ is turned off. The current flowing through the primary winding of the transformer has a direction a, thus the current flowing through the secondary winding of the transformer has a direction b. The diode Dᵣ₁ is reverse biased, and the diode Dᵣ₂ is forward biased. Thus the current (i_{Lo1}) flowing through the first inductor Lₒ₁ increases, and the current (i_{Lo2}) flowing through the second inductor Lₒ₂ decreases. The balance capacitor C_{b} is charged during this subinterval. In subinterval t₁-t₂, the first switch Sᵢ and the second switch S₂ are turned off, both the diodes Dᵣ₁ and Dᵣ₂ are reverse biased, and the currents i_{Lo1} and i_{Lo2} decrease. During subinterval t₂-t₃, the first switch S₁ is turned off and the second switch S₂ is turned on. The current flowing through the primary winding of the transformer has an opposite direction to direction a, thus the current flowing through the secondary winding of the transformer has an opposite direction to direction b. The diode Dᵣ₂ is reverse biased, and the diode Dᵣ₁ is forward biased. Thus the current (i_{Lo1}) flowing through the first inductor Lₒ₁ decreases, and the current (i_{Lo2}) flowing through the second inductor Lₒ₂ increases. The balance capacitor C_{b} is discharged during this subinterval. In subinterval t₃-t₄, the first switch S₁ and the second switch S₂ are both turned off, both the diodes Dᵣ₁ and Dᵣ₂ are reverse biased, and the currents i_{Lo1} and i_{Lo2} decrease.

As is seen from FIG. 4, the balance capacitor C_{b} is charged in subinterval t₀-t₁ and is discharged in subinterval t₂-t₃, so in steady state, the charges Q₁ stored to the capacitor C_{b} in subinterval t₀-t₁ is equal to the charges Q₂ released from the capacitor C_{b} in subinterval t₂-t₃ in every cycle. The charges Q₁ and the charges Q₂ could be written as:

Q₁=∫₀^{T}i_{Lo1}(t)dt=I_{Lo1}×(t₁−t₀)Q₂=∫₀^{T}i_{Lo2}(t)dt=I_{Lo2}×(t₃−t₂)

Wherein T represents the cycle time of the circuit 100; i_{Lo1} represents the current of the inductor L₀₁, and i_{Lo2} represents the current of the inductor Lₒ₂; I_{Lo1} represents the average current of the inductor Lₒ₁, and I_{Lo2} represents the average current of the inductor Lₒ₂; t₁−t₀ represents the charging time, and t₃−t₂ represents the discharging time.

If t₁−t₀₌ₜ₃−t₂, we get L_{Lo1}=I_{Lo2}. The average current of the inductor is respectively corresponding to the current flowing through the LED string. Therefore the current balance in two LED strings is achieved by matching the charging time and the discharging time of the balance capacitor C_{b}.

FIG. 4 only shows the waveforms of the signals in the circuit 100 working under continuous current mode (CCM). Persons of ordinary skill in the art should know that the circuit could work under discontinuous current mode (DCM), or critical conduction mode without detracting from the merits of the present disclosure.

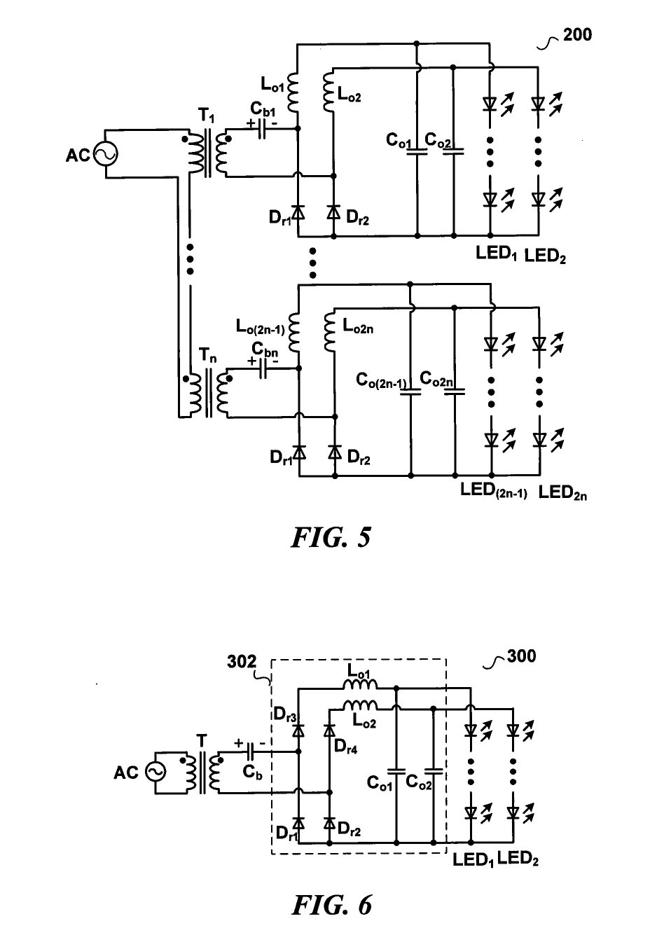

In the example of FIG. 3, there are only two LED strings, to have more LED strings be current balanced, multi transformers and secondary converters may be configured. FIG. 5 schematically shows a circuit 200 in accordance with an embodiment of the present disclosure. In the example of FIG. 5, the circuit 200 comprises: a transformer set comprising N transformers, wherein N is natural number, and each transformer respectively comprises a primary winding and a secondary winding, wherein all the primary windings are serially coupled to an AC signal, and each secondary winding has a first terminal and a second terminal; a balance capacitor set comprising N balance capacitors, wherein N is a natural number, and wherein each balance capacitor has a first terminal and a second terminal, wherein the first terminal of each balance capacitor is respectively coupled to the first terminal of each secondary winding of the transformer set; and a secondary converter set comprising N secondary converters, wherein N is a natural number, and wherein each secondary converter has a first input terminal, a second input terminal, a first output terminal, and a second output terminal, wherein the first input terminal of each secondary converter is respectively coupled to the second terminal of each balance capacitor, the second input terminal of each secondary converter is respectively coupled to the second terminal of each secondary winding of the transformer set, and each output terminal of the secondary converter set provides a drive signal to a respective LED string.

In one embodiment, the circuit 200 further comprises a primary converter configured to receive a DC signal, and provide the AC signal based thereupon.

Each secondary converter in FIG. 5 has a same structure as the secondary converter 102 in FIG. 3. The example in FIG. 5 is a combination of the example in FIG. 3. Because the primary winding of each transformer is coupled in series, the current in the secondary winding of each transformer is equal to each other. The operation of the circuit 200 in FIG. 5 is similar to the operations of the circuit 100 in FIG. 3.

FIG. 6 schematically shows a circuit 300 in accordance with an embodiment of the present disclosure. Compared to the embodiment in FIG. 3, the secondary converter 302 in FIG. 6 comprises: a first diode Dᵣ₁, a second diode Dᵣ₂, a third diode Dᵣ₃, a fourth diode Dᵣ₄, a first inductor Lₒ₁ and a second inductor Lₒ₂, wherein each diode has a cathode and an anode, and wherein the cathode of the first diode Dᵣ₁ and the anode of the third diode Dᵣ₃ are coupled together to the first input terminal of the secondary converter; the cathode of the second diode Dᵣ₂ and the anode of the fourth diode Dᵣ₄ are coupled together to the second input terminal of the secondary converter 302; the first inductor Lₒ₁ is coupled between the cathode of the third diode Dᵣ₃ and the first output terminal of the secondary converter 302; the second inductor Lₒ₂ is coupled between the cathode of the fourth diode Dᵣ₄ and the second output terminal of the secondary converter 302; and wherein the anodes of the first and second diodes are coupled to the ground node.

The secondary converter 302 in FIG. 6 further comprises: a first output capacitor Cₒ₁, coupled between the first output terminal of the secondary converter 302 and the ground node; and a second output capacitor Cₒ₂, coupled between the second output terminal of the secondary converter 302 and the ground node.

The operation of the circuit 300 in FIG. 6 is similar to the operation of the circuit 100 in FIG. 3. The balance capacitor C_{b} is charged and discharged in a cycle time. Matching the charging time and the discharging time achieves the current balance in LED strings.

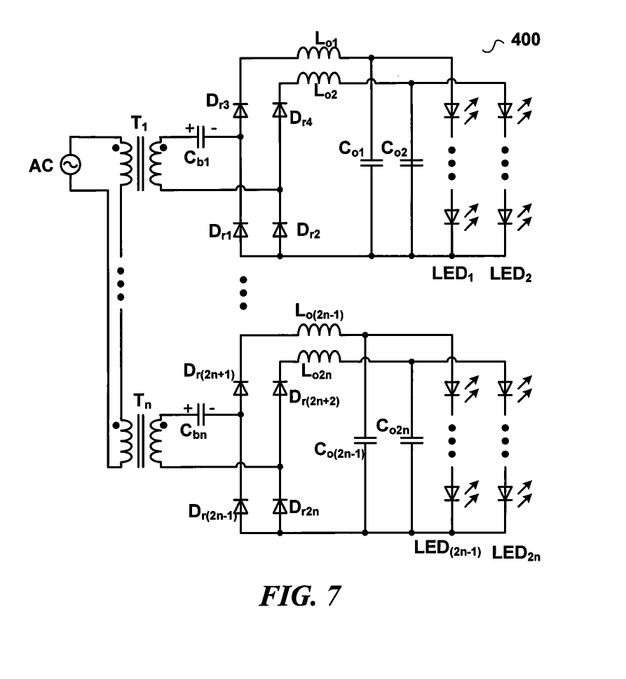

FIG. 7 schematically shows a circuit 400 in accordance with an embodiment of the present disclosure. The example of FIG. 7 is a combination of the circuit 300 in FIG. 6, and the operation of the circuit 400 in FIG. 7 is similar to that of the circuit 300 in FIG. 6.

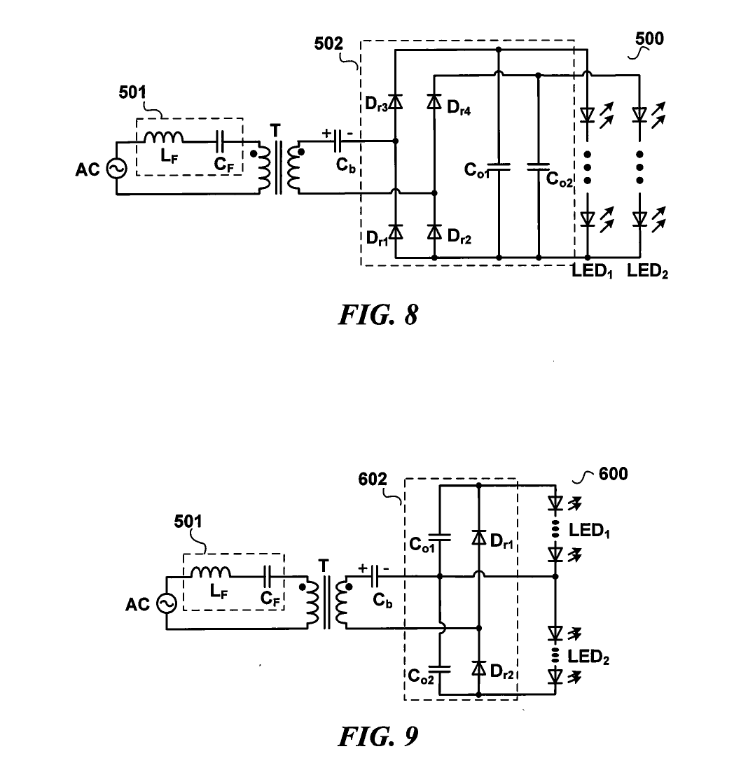

FIG. 8 schematically shows a circuit 500 in accordance with an embodiment of the present disclosure. Compared to the circuit 100 in FIG. 3, a resonant unit 501 is coupled between the AC signal and the primary winding of the transformer T. The resonant unit 501 comprises an inductor L_{F} and a capacitor C_{F} coupled in series. The resonant unit 501 makes the signal transferred from the primary side to the secondary side be a current signal, so there is no need to configure inductors to the secondary converter. The secondary converter 502 in this embodiments comprises a first diode Dᵣ₁, a second diode Dᵣ₂, a third diode Dᵣ₃, a fourth diode Dᵣ₄, a first output capacitor Cₒ₁ and a second output capacitor Cₒ₂; wherein each diode has a cathode and an anode, the cathode of the first diode Dᵣ₁ and the anode of the third diode Dᵣ₃ are coupled together to the first input terminal of the secondary converter 502; the cathode of the second diode Dᵣ₂ and the anode of the fourth diode Dᵣ₄ are coupled together to the second input terminal of the secondary converter 502; the cathode of the third diode Dᵣ₃ is the first output terminal of the secondary converter 502; the cathode of the fourth diode Dᵣ₄ is the second output terminal of the secondary converter 502; the first output capacitor Cₒ₁ is coupled between the first output terminal of the secondary converter 502 and the ground node; and the second output capacitor Cₒ₂ is coupled between the second output terminal of the secondary converter 502 and the ground node.

As is seen from FIG. 8, the secondary converter 502 is a deformation of a typical full-bridge secondary converter and is similar to the secondary converter 302 in FIG. 6 except there is no inductor in the secondary converter in FIG. 8.

The operation of the circuit 500 in FIG. 8 is similar to the operation of the circuit 100 in FIG. 3 except that the signal supplied to the primary winding of the transformer in the circuit 500 in FIG. 8 is a current signal. The balance capacitor C_{b} is charged and discharged in a cycle time. Matching the charging time and the discharging time achieves the current balance in LED strings.

FIG. 9 schematically shows a circuit 600 in accordance with an embodiment of the present disclosure. Similarly to the circuit 500 of FIG. 8, there is a resonant unit 501 coupled between the AC signal and the primary winding of the transformer T. The resonant unit 501 comprises an inductor L_{F} and a capacitor C_{F} coupled in series. The resonant unit 501 makes the signal transferred from the primary side to the secondary side be a current signal, so there is no need to configure inductors to the secondary converter. The secondary converter 602 in this embodiment comprises: a first diode Dᵣ₁ having a cathode and an anode, a second diode Dᵣ₂ having a cathode and an anode, a first output capacitor Cₒ₁ having a first terminal and a second terminal, and a second output capacitor Cₒ₂ having a first terminal and a second terminal, wherein: the first terminal of the first capacitor Cₒ₁ and the second terminal of the second capacitor Cₒ₂ are coupled together to the first input terminal of the secondary converter 602; the anode of the first diode Dᵣ₁ and the cathode of the second diode Dᵣ₂ are coupled together to the second input terminal of the secondary converter 602; the cathode of the first diode Dᵣ₁ and the second terminal of the first capacitor Cₒ₁ are coupled together to the first output terminal of the secondary converter 602; the anode of the second diode Dᵣ₂ and the first terminal of the second capacitor Cₒ₂ are coupled together to the second output terminal of the secondary converter 602; and two loads are connected in series between the first output terminal and the second output terminal of the secondary converter 602, wherein the common connection of the serial loads is coupled to the first input terminal of the secondary converter 602.

The operation of the circuit 600 in FIG. 9 is similar to the operation of the circuit 100 in FIG. 3 except the signal supplied to the primary winding of the transformer in the circuit 600 in FIG. 9 is a current signal. The balance capacitor C_{b} is charged and discharged in a cycle time. Matching the charging time and the discharging time achieves the current balance among loads.

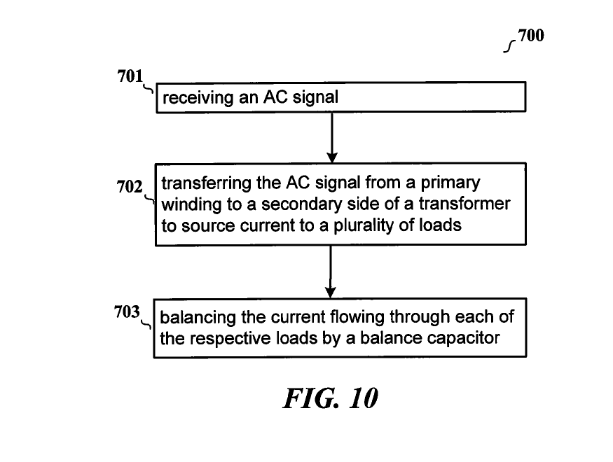

Furthermore, the present disclosure discloses a method for current balance. Referring to FIG. 10, a schematic flowchart 700 of the method is shown in accordance with an embodiment of the present disclosure. In the embodiment of FIG. 10, the method comprises: step 701, receiving an AC signal; step 702, transferring the AC signal from a primary winding to a secondary side of a transformer to source current to a plurality of loads; step 703 balancing the current flowing through each of the respective loads by a balance capacitor.

In one embodiment, the step 703 balancing the current in the loads by a balance capacitor comprises: charging the balance capacitor in a first direction for a first time period; and discharging the balance capacitor in a second direction for a second time period; wherein the first direction is opposite from the second direction; and the first time period and the second time period are substantially similar.

Improved circuit and method for current balance in controlling parallel loads have been disclosed. While specific embodiments of the present disclosure have been provided, it is to be understood that these embodiments are for illustration purposes and not limiting. Many additional embodiments will be apparent to persons of ordinary skill in the art reading this disclosure.

I/we claim:

1. A circuit, comprising:
a transformer comprising a primary winding and a secondary winding, wherein the primary winding is coupled to an AC signal, and the secondary winding has a first terminal and a second terminal;
a balance capacitor having a first terminal and a second terminal, wherein the first terminal of the balance capacitor is coupled to the first terminal of the secondary winding of the transformer; and
a secondary converter having a first input terminal, a second input terminal, a first output terminal, and a second output terminal, wherein the first input terminal is coupled to the second terminal of the balance capacitor, the second input terminal is coupled to the second terminal of the secondary winding of the transformer, and either the first or second output terminal provides a drive signal to a load.

2. The circuit of claim 1, wherein the charging time and the discharging time of the balance capacitor are substantially similar.

3. The circuit of claim 1, wherein the secondary converter comprises:
a first diode having a cathode and an anode, wherein the cathode is coupled to the first input terminal of the secondary converter, and the anode is coupled to a ground node;
a second diode having a cathode and an anode, wherein the cathode is coupled to the second input terminal of the secondary converter, and the anode is coupled to the ground node;
a first inductor coupled between the cathode of the first diode and the first output terminal of the secondary converter; and
a second inductor coupled between the cathode of second diode and the second output terminal of the secondary converter.

4. The circuit of claim 3, wherein the secondary converter further comprises:
a first output capacitor coupled between the first output terminal of the secondary converter and the ground node; and
a second output capacitor coupled between the second output terminal of the secondary converter and the ground node.

5. The circuit of claim 1, wherein the secondary converter comprises a first diode, a second diode, a third diode, a fourth diode, a first inductor and a second inductor, wherein each diode has a cathode and an anode; and wherein
the cathode of the first diode and the anode of the third diode are coupled together to the first input terminal of the secondary converter;
the cathode of the second diode and the anode of the fourth diode are coupled together to the second input terminal of the secondary converter;
the first inductor is coupled between the cathode of the third diode and the first output terminal of the secondary converter;
the second inductor is coupled between the cathode of the fourth diode and the second output terminal of the secondary converter; and
wherein the anodes of the first and second diodes are coupled to a ground node.

6. The circuit of claim 5, wherein the secondary converter further comprises:
a first output capacitor, coupled between the first output terminal of the secondary converter and the ground node; and
a second output capacitor, coupled between the second output terminal of the secondary converter and the ground node.

7. The circuit of claim 1, wherein a resonant unit is coupled between the AC signal and the primary winding of the transformer.

8. The circuit of claim 7, wherein the secondary converter comprises a first diode, a second diode, a third diode, a fourth diode, a first output capacitor and a second output capacitor; wherein: each diode has a cathode and an anode; and wherein
the cathode of the first diode and the anode of the third diode are coupled together to the first input terminal of the secondary converter;
the cathode of the second diode and the anode of the fourth diode are coupled together to the second input terminal of the secondary converter;
the cathode of the third diode is coupled to the first output terminal of the secondary converter;
the cathode of the fourth diode is coupled to the second output terminal of the secondary converter;
the first output capacitor is coupled between the first output terminal of the secondary converter and the ground node; and
the second output capacitor is coupled between the second output terminal of the secondary converter and the ground node.

9. The circuit of claim 7, wherein the secondary converter comprises: a first diode having a cathode and an anode, a second diode having a cathode and an anode, a first output capacitor having a first terminal and a second terminal, and a second output capacitor having a first terminal and a second terminal, wherein:
the first terminal of the first capacitor and the second terminal of the second capacitor are coupled together to the first input terminal of the secondary converter;
the anode of the first diode and the cathode of the second diode are coupled together to the second input terminal of the secondary converter;
the cathode of the first diode and the second terminal of the first capacitor are coupled together to the first output terminal of the secondary converter;
the anode of the second diode and the first terminal of the second capacitor are coupled together to the second output terminal of the secondary converter; and
two loads are connected in series between the first output terminal and the second output terminal of the secondary converter, wherein the common connection of the serial loads is coupled to the first input terminal of the secondary converter.

10. The circuit of claim 1, further comprising a primary converter configured to receive a DC signal, and provide the AC signal based thereupon.

11. A circuit, comprising:
a transformer set comprising N transformers, wherein N is a natural number, and each transformer respectively comprises a primary winding and a secondary winding, wherein all the primary windings are serially coupled to an AC signal, and each secondary winding has a first terminal and a second terminal;
a balance capacitor set comprising N balance capacitors, wherein N is a natural number, and wherein each balance capacitor has a first terminal and a second terminal, wherein the first terminal of each balance capacitor is respectively coupled to the first terminal of each secondary winding of the transformer group; and
a secondary converter set comprising N secondary converters, wherein N is a natural number, and wherein each secondary converter has a first input terminal, a second input terminal, a first output terminal, and a second output terminals, wherein the first input terminal of each secondary converter is respectively coupled to the second terminal of each balance capacitor, the second input terminal of each secondary converter is respectively coupled to the second terminal of each secondary winding of the transformer set, and each output terminal of the secondary converter set provides a drive signal to a respective load.

12. The circuit of claim 11, wherein the charging time and the discharging time of each balance capacitor are substantially similar.

13. The circuit of claim 11, wherein each of the N secondary converters respectively comprises:
a first diode having a cathode and an anode, wherein the cathode is coupled to the first input terminal of the secondary converter, and the anode is coupled to a ground node;
a second diode having a cathode and an anode, wherein the cathode is coupled to the second input terminal of the secondary converter, and the anode is coupled to the ground node;
a first inductor coupled between the cathode of the first diode and the first output terminal of the secondary converter; and
a second inductor coupled between the cathode of second diode and the second output terminal of the secondary converter.

14. The circuit of claim 13, wherein each of the N secondary converters respectively further comprises:
a first output capacitor coupled between the first output terminal of the secondary converter and the ground node; and
a second output capacitor coupled between the second output terminal of the secondary converter and the ground node.

15. The circuit of claim 11, wherein each of the N secondary converters respectively comprises a first diode, a second diode, a third diode, a fourth diode, a first inductor and a second inductor; wherein each diode has a cathode and an anode; and wherein
the cathode of the first diode and the anode of the third diode are coupled together to the first input terminal of the secondary converter;
the cathode of the second diode and the anode of the fourth diode are coupled together to the second input terminal of the secondary converter;
the first inductor is coupled between the cathode of the third diode and the first output terminal of the secondary converter;
the second inductor is coupled between the cathode of the fourth diode and the second output terminal of the secondary converter; and
wherein the anodes of the first and second diodes are coupled a ground node.

16. The circuit of claim 15, wherein each of N secondary converters respectively further comprises:
a first output capacitor, coupled between the first output terminal of the secondary converter and the ground node; and
a second output capacitor, coupled between the second output terminal of the secondary converter and the ground node.

17. The circuit of claim 11, further comprising a primary converter configured to receive a DC signal, and to provide the AC signal based thereupon.

18. A method for current balancing, the method comprising:
receiving an AC signal;
transferring the AC signal from a primary winding to a secondary side of a transformer to source current to a plurality of loads;
balancing the current flowing through each of the respective loads by a balance capacitor.

19. The method of claim 18, wherein balancing the current of the loads by a balance capacitor comprises:
charging the balance capacitor in a first direction for a first time period; and
discharging the balance capacitor in a second direction for a second time period;
wherein
the first direction is opposite from the second direction; and
the first time period and the second time period are substantially similar.
